(19) United States
(12) Patent Application Publication
(10) Pub. No.: US 2024/0068863 A1
(43) Pub. Date: Feb. 29, 2024

(54) Luggage with Built-In Electronic Scale

(71) Applicant: Valenti, LLC, Ellicott City, MD (US)

(72) Inventors: Cristiana Valentini KATSU, Ellicott City, MD (US); Ozer CULHAGIL, Ellicott City, MD (US)

(73) Assignee: Valenti, LLC, Ellicott City, MD (US)

(21) Appl. No.: 18/503,437

(22) Filed: Nov. 7, 2023

Related U.S. Application Data
(63) Continuation of application No. PCT/US2022/028210, filed on May 6, 2022.
(60) Provisional application No. 63/185,561, filed on May 7, 2021.

(51) Int. Cl. G01G 19/52; A45C 13/00

(52) U.S. Cl. CPC G01G 19/52; A45C 13/001

(57) ABSTRACT

A luggage case includes: a base configured to accommodate items therein; a cover disposed on the base; and a scale. The scale includes: one or more load sensors disposed on the base; and a controller configured to determine a weight of the luggage case based on signals generated by the one or more load sensors. The scale is configured to be automatically powered on in response to the cover being placed in an open position at least partially exposing an interior space of the base. The scale is configured to be automatically powered off in response to the cover being placed in a closed position in which the cover and the base enclose an interior space of the luggage case.

### CROSS-REFERENCE TO RELATED APPLICATION(S)

This application is a continuation of International Application No. PCT/US2022/028210 filed on May 6, 2022, which claims the benefit under 35 USC § 119(e) of U.S. Provisional Application No. 63/185,561 filed on May 7, 2021, the entire disclosure of which is incorporated herein by reference for all purposes.

### BACKGROUND

### 1. Field

The following description relates to luggage including a scale for weighing the luggage and contents stored therein.

### 2. Description of Related Art

The ability to quickly, easily, and accurately weigh luggage is important for people traveling by various forms of transportation, due to restrictions that transportation carriers continue to place on luggage weight. For example, many common carriers, such as airline companies, have implemented increased surcharges for passengers having luggage exceeding certain weight limits. Additionally, airline companies continue to impose strict weight limitations on carry-on luggage. In view of these issues, luggage with built-in electronic scales has been developed to enable people to weigh their own luggage when preparing to travel.

However, the self-weighing function of some existing luggage cases is implemented in a manner that can be inconvenient and energy inefficient. For example, some luggage cases must be lifted by a person in order for the scale included with the case to determine the weight of the luggage case. In such luggage cases, it is not possible to weight the luggage case while loading items in the luggage case, since the luggage case must be closed and lifted to obtain the weight.

Additionally, existing self-weighing luggage cases that include electronic scales may be susceptible to the scales accidentally being powered on during storage or transport of the luggage cases. This may cause excessive power consumption that decreases the life of batteries used to power the scales, and may result in inadvertent violations of Transportation Security Administration (TSA) and Federal Aviation Administration (FAA) airline regulations requiring electronic devices to be powered off at certain times during air travel.

Accordingly, there is a need for a self-weighing luggage case that provides a weighing function that is convenient, energy efficient, and airline regulation-friendly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a luggage case includes: a base configured to accommodate items therein; a cover disposed on the base; and a scale including: one or more load sensors disposed on the base, and a controller configured to determine a weight of the luggage case based on signals generated by the one or more load sensors, wherein the scale is configured to be automatically powered on in response to the cover being placed in an open position at least partially exposing an interior space of the base.

The scale may be configured to remain powered on only when the cover is in the open position.

The scale may further include: a magnetic switch connected to a power source and the controller, and including a sensing member disposed in the base; and a magnet disposed in the cover. The magnetic switch may be configured to electrically connect the controller to the power source, in response to the sensing member failing to sense the magnet.

The sensing member may be disposed at an edge portion of the base and the magnet is disposed at an edge portion of the cover that aligns with the edge portion of the base when the cover is in a closed position in which the cover and the base enclose an interior space of the luggage case.

The luggage scale may further include a display disposed in a display housing mounted at or near a side wall of the base, the display being configured to display weight information indicating the determined weight. The sensing member may be disposed in or on the display housing, and the magnet may be disposed at an edge portion of the cover that aligns with the display housing when the cover is in a closed position in which the cover and the base enclose an interior space of the luggage case.

The scale may be further configured to be automatically powered off in response to the cover being placed in a closed position in which the cover and the base enclose an interior space of the luggage case.

The scale may further include: a magnetic switch connected to a power source and the controller, and including a sensing member disposed in the base; and a magnet disposed in the cover. The magnetic switch may be configured to electrically disconnect the controller from the power source, in response to the sensing member sensing the magnet.

The scale may be further configured to power down to a low power mode, in response to the controller determining that loading of items in the luggage case has stopped while the cover is in the open position.

The scale may further include a display configured to display weight information indicating the determined weight. The display may be disabled in the low power mode.

The scale may be configured to return to a fully operational mode from the low power mode, in response to an input from a command button on the luggage case.

The scale may further include a display configured to display weight information based on the determined weight.

The controller may be further configured to redetermine the weight of the luggage case in response to an item being placed in the luggage case. The display may be further configured to update the displayed weight information based on the redetermined weight.

The display may be configured to change units of measurement of the displayed weight information, in response to an input from a command button.

In another general aspect, a luggage case includes: a base configured to accommodate items therein; a cover disposed on the base; and a scale including: one or more load sensors disposed on the base, and a controller configured to determine a weight of the luggage case based on signals generated by the one or more load sensors, wherein the scale is configured to be automatically powered off in response to the cover being placed in a closed position in which the cover and the base enclose an interior space of the luggage case.

The scale may be further configured to always remain powered off when the cover is in the closed position.

The scale may further include: a magnetic switch connected to a power source and the controller, and including a sensing member disposed in the base; and a magnet disposed in the cover. The magnetic switch may be configured to electrically disconnect the controller from the power source, in response to the sensing member sensing the magnet.

The sensing member may be disposed at an edge portion of the base and the magnet is disposed at an edge portion of the cover that aligns with the edge portion of the base when the cover is in the closed position.

The scale may further include a display disposed in a display housing mounted at or near a side wall of the base, the display being configured to display weight information indicating the determined weight. The sensing member may be disposed in or on the display housing, and the magnet may be disposed at an edge portion of the cover that aligns with the display housing when the cover is in the closed position.

In another general aspect, a method of weighing a luggage case includes: placing a cover of the luggage case in an open position at least partially exposing an interior space of a base of the luggage case; powering on an electronic scale in the luggage case, in response to the cover being placed in the open position; and measuring, by a controller of the electronic scale, a weight of the luggage case based on weight data generated from signals generated by one or more load sensors disposed on the luggage case.

The method may further include updating a display of the electronic scale to display weight information corresponding to the generated weight data.

The method may further include further measuring a weight of the luggage case, in response to the controller determining that there is a change in the weight data generated from the signals.

The method may further include further measuring a weight of the luggage case, in response to the controller determining that: there is no change in the weight data generated from the signals; and a count of a timer started before the measuring of the weight does not exceed a threshold count.

The method may further include powering down the electronic scale to a low power mode, in response to the controller determining that: there is no change in the weight data generated from the signals; and a count of a timer started before the measuring of the weight exceeds a threshold count.

The method may further include returning the electronic scale to a fully operational mode from the low power mode, in response to an input received from a command button.

The method may further include powering off the electronic scale, in response to the cover being placed in a closed position in which the cover and the base enclose an interior space of the luggage case.

Other features and aspects will be apparent from the following detailed description, the drawings, and the claims.

### BRIEF DESCRIPTION OF DRAWINGS

FIGS. 1 and 2 are perspective views of a luggage case standing upright in a closed configuration, according to an embodiment.

FIG. 3 is a front view of the luggage case standing upright in the closed configuration.

FIG. 4 is a rear view of the luggage case standing upright in the closed configuration.

FIG. 5 is a top view of the luggage case standing upright in the closed configuration.

FIG. 6 is a bottom view of the luggage case standing upright in the closed configuration.

FIGS. 7 and 8 are side views of the luggage case standing upright in the closed configuration.

FIGS. 9 and 10 show the luggage case lying on a rear side thereof in an open configuration.

FIG. 11 is a schematic diagram of a scale of the luggage case, according to an embodiment.

FIG. 12 illustrates a display housing including a display of the scale, according to an embodiment.

FIG. 13 is a schematic diagram of a scale of the luggage case, according to another embodiment.

FIG. 14 is a flow chart illustrating a method of weighing the luggage case, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower,” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

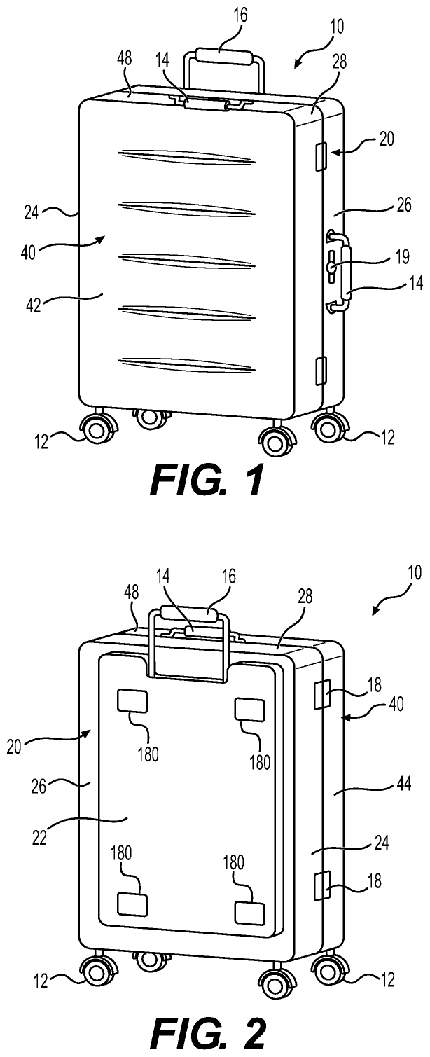

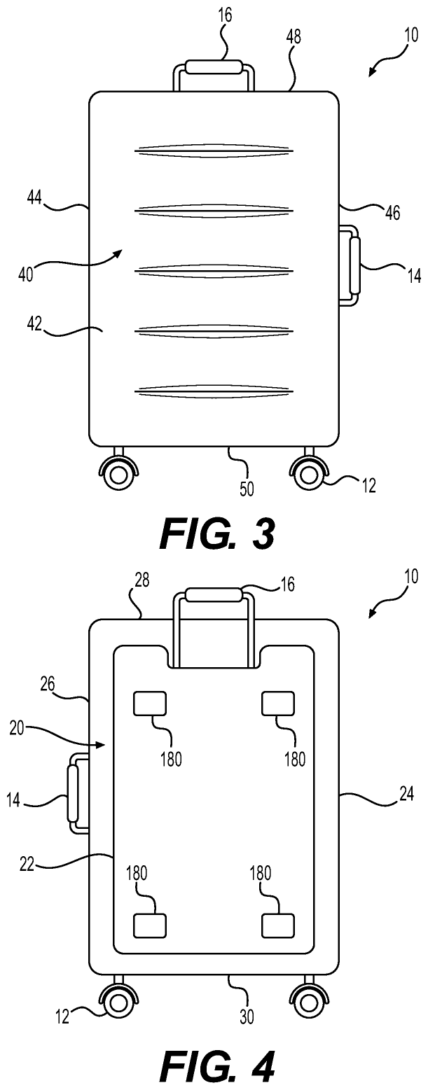

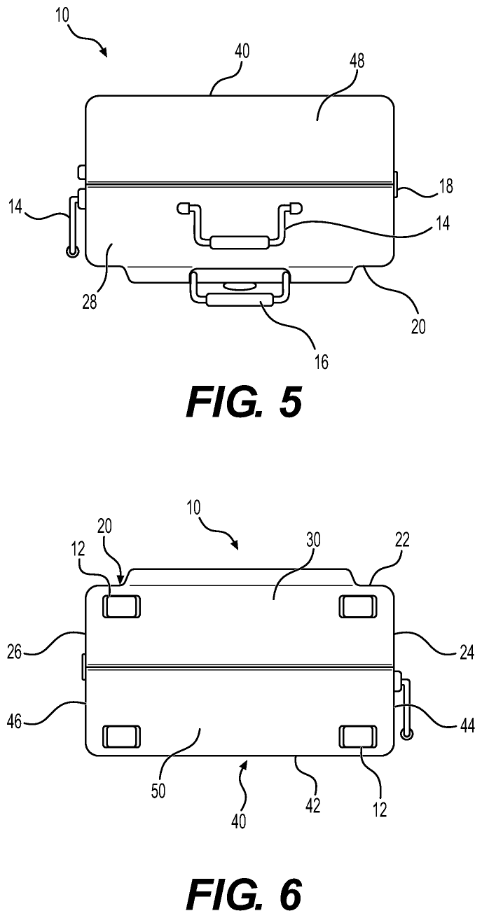

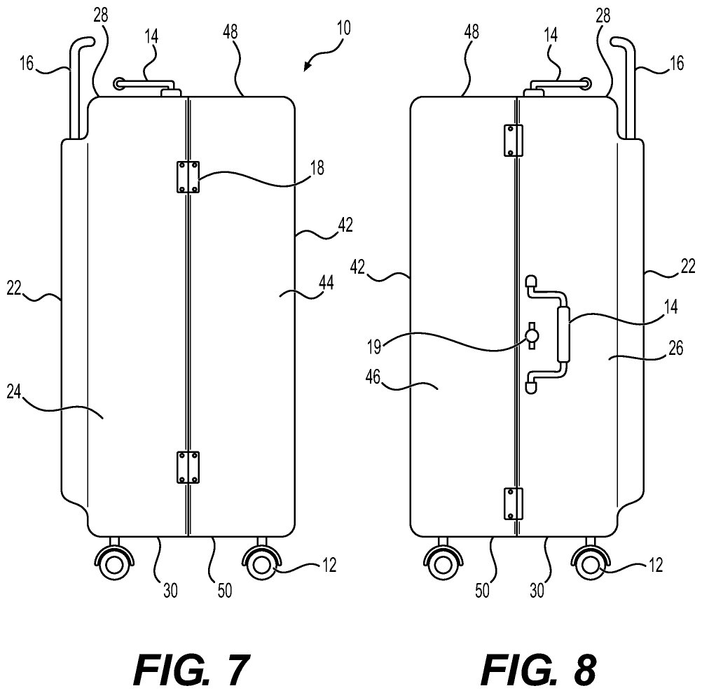

FIGS. 1-8 illustrate a luggage case 10, according to an embodiment.

Referring to FIGS. 1-8, which illustrate the luggage case 10 standing upright position, the luggage case 10 includes a base (or body portion) 20 and a cover (or lid) 40.

The base 20 defines an interior space 21 for storing items (e.g., clothing, clothing accessories, shoes, personal items, toiletries, tools, etc.) therein. The base 20 may include a rear panel 22 forming a rear panel of the luggage case 10, and side panels, 24, 26, 28, and 30 integrally formed with the rear panel 22. The side panels, 24, 26, 28, and 30 may extend substantially perpendicular to the rear panel 22 along a perimeter thereof. Thus, the base 20 may form tub having a generally rectangular shape. However, other shapes are possible for the base 20.

For example, the rear panel 22 and the side panels 24, 26, 28, and 30 may be made of hard plastic, metal, fabric, vinyl, leather, or any combination of any two or more of hard plastic, metal, fabric, vinyl, and leather. However, the rear panel 22 and the side panels 24, 26, 28, and 30 are not limited to the foregoing materials.

Wheels 12 may be attached to one or more of the side panels 24, 26, 28, and 30, and may support the luggage case 10 in the upright position shown in FIGS. 1-8 so that the luggage case 10 may be rolled along the ground or other support surface.

One or more carry handles 14 may be attached to the base 20 to enable a person to carry the luggage case 10 in his or her hand. For example, one or more carry handles 14 may be attached to one or more of the side panels 24, 26, 28, and 30, respectively. The luggage case 10 may further include an extendable handle 16 that may be pulled outward from the luggage case 10 for a person to hold while rolling the luggage case 10 along the ground or other support surface, and pushed inward into the luggage case 10 when the luggage case 10 is not being rolled. The extendable handle 16 may be formed in the side panel 28, for example. In embodiments, the carry handles 14 and the extendable handle 16 may be made entirely of carbon fiber to reduce the weight of the luggage case 10 and to provide the carry handles 14 and the extendable handle 16 with superior strength and rigidity.

The cover 40 is attached to the base 20 and may include a front panel 42 forming a front panel of the luggage case 10, and side panels 44, 46, 48, and 50 integrally formed with the front panel 42. The side panels 44, 46, 48, and 50 may extend substantially perpendicular to the front panel 42 along a perimeter thereof. Thus, the cover 40 may form tub having a generally rectangular shape matching that of the base 20. However, other shapes are possible for the cover 40. For example, the cover 40 may have a substantially flat lid shape forming only the front panel of the luggage case 10.

For example, the front panel 42 and the side panels 44, 46, 48, and 50 may be made of hard plastic, metal, fabric, vinyl, leather, or any combination of any two or more of hard plastic, metal, fabric, vinyl, and leather. However, the front panel 42 and the side panels 44, 46, 48, and 50 are not limited to the foregoing materials.

In an alternative embodiment, the one or more carry handles 14 and/or the extendable handle 16 may be attached to the cover 40 instead of the base 20.

When the luggage case 10 is in the closed configuration (in which the cover 40 and the base 20 enclose an interior space of the luggage case 10) shown in FIGS. 1-8, the side panels 24, 26, 28, and 30 of the base 20 may be aligned with the side panels 44, 46, 48, and 50 of the cover 40, respectively, to thereby form respective side panels of the luggage case 10.

The cover 40 may be foldably attached to one of the side panels (e.g., the side panel 24) of the base 20 along a fold line or hinge interface formed by hinges 18, For example, the hinges 18 may connect the side panels 24 and 44 to each other. The cover 40 may be selectively attached to others of the side panels (e.g., the side panels 26, 28, and 30) of the base 20 by a closure mechanism. For example, the side panels 46, 48, and 50 of the cover 40 may be selectively attached to the side panels 26, 28, and 30 of the base 20, respectively, by the closure mechanism.

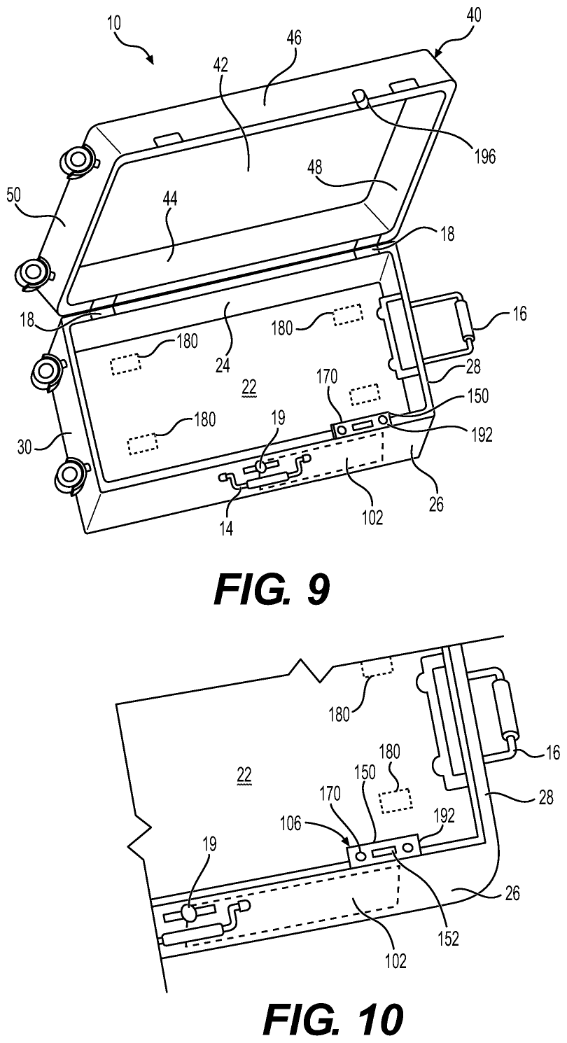

The closure mechanism may include, for example, internal clamping members operated by an external lever 19. Alternatively, the closure mechanism may include one or more fasteners, such as a zipper, external clamps, or external clasps. Accordingly, the luggage case 10 may be placed in the closed configuration (e.g., a configuration in which all of the side panels 44, 46, 48, and 30 of the cover 40 are attached to the base 20) shown in FIGS. 1-8 by folding the cover 40, with respect to the one of the side panels (e.g., the side panel 24), into a closed position and securing the cover 40 in the closed position by closing the closure mechanism. The luggage case 10 may be placed in the open configuration (e.g., a configuration in which one or more of the sidewalls 46, 48, and 50 of the cover 40 are at least partially separated from the base 20) shown in FIGS. 8 and 9 by opening the closure mechanism and folding the cover 40 with respect to the one of the side panels (e.g., the side panel 24), into an open position exposing an interior space of the base 20.

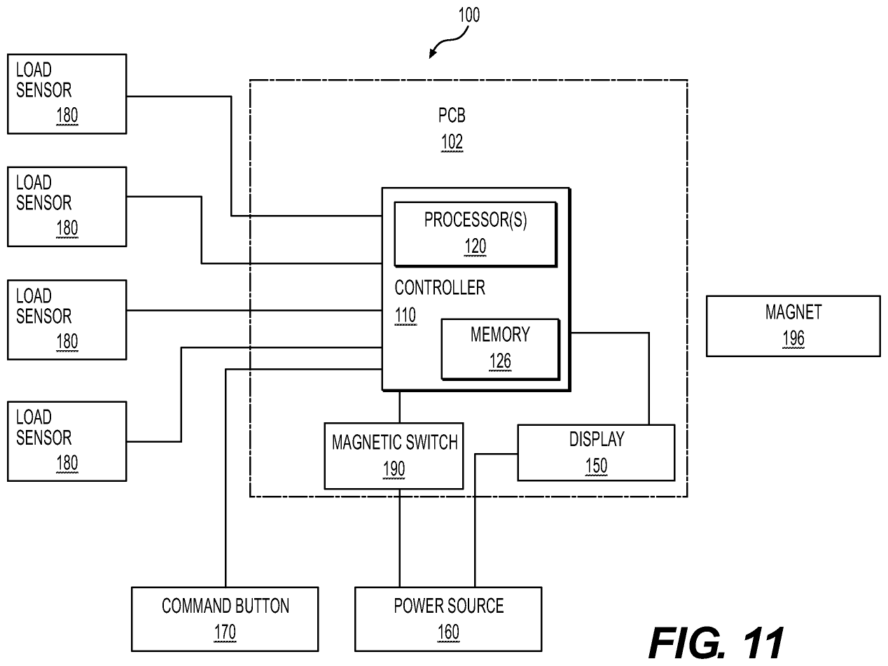

Referring to FIG. 11, the luggage case 10 may include an electronic scale (hereinafter, “scale”) 100 configured to determine and indicate a weight (e.g., a total weight including a weight of items placed in the luggage case 10) of the luggage case 10. The scale 100 may be a digital scale. The scale 100 may include, for example, a controller 110 configured to control operations of the scale 100, a display 150 electrically connected to the controller 110, a command button 170 electrically connected to the controller 110, and one or more load sensors 180 electrically connected to the controller 110. A power source 160 may be selectively electrically connected to the controller 110. The scale 100 may further include a magnetic switch 190 connected to the controller, and a magnet 196 configured to magnetically interface with the magnetic switch 190.

In an embodiment controller 110 may include one or more processors 120 and memory 126 configured to store information calculated by the one or more processors 120 and provide stored information to the one or more processors 120. The memory 126 may also store program instructions that are executable by the one or more processors 120 to perform weighing and display functions of the scale 100.

As shown in FIG. 11, the controller 110 may be mounted on a printed circuit board (PCB) 102. As shown in FIGS. 9 and 10, the PCB 102 may be mounted on an interior side of the side panel 26 of the base 20, or in an interior space of the side panel 26. However, this configuration is merely an example, and the PCB 102 may be mounted on or in one of the other side panels 24, 28, and 30 of the base 20, or may be mounted on or in the rear panel 22 of the base 20.

The display 150 is configured to display weight information indicating the weight (e.g., the total weight inclusive of any stored contents) of the luggage case 10 determined by the controller 110. That is, the controller 110 may determine the weight of the luggage case 10, as described in more detail below, and may control the display 150 to display weight information indicating the weight of the luggage case 10. For example, the controller 110 may control the display 150 to display numeric weight information in one or more different units of measurement (e.g., kilograms (kg) and/or pounds (lbs)), as described in more detail below. In an example, the display 150 may be an LCD display. However, other types of displays may be used for the display 150.

Referring to FIGS. 10 and 11, the display 150 may be mounted on the PCB 102, within in a display housing 106. As shown in FIGS. 9 and 10, the display housing 106 may be mounted along with the PCB 102 on the interior side of the side panel 26 of the base 20, or in the interior space of the side panel 26. In another example, the display housing 106 may disposed adjacent to the PCB 102, and the display 150 may be mounted in the display housing 106, separately from the PCB 102. The display housing 106 and display 150 may be positioned such that the display 150 is exposed at a surface of an outer edge of the side panel 26, and the display faces outward such that the weight information displayed by the display 150 is easily visible when the cover 40 is opened. Additionally, a display screen 152 of the display 150 may be arranged in a plane perpendicular to a plane in which the side panel 26 lies, such that the display screen 152 and the weight information displayed thereon are only exposed to an outside of the luggage case 10 when the luggage case 10 is in the open configuration. However, this configuration is merely an example, and the display housing 106 including the display 150 may be mounted on or in one of the other side panels 24, 28, and 30 of the base 20. Further the display 150 may be arranged to face outward on any outer surface portion of one or more of side panels 24, 28, and 30, as long as the display 150 is visible to a person using the luggage case 10.

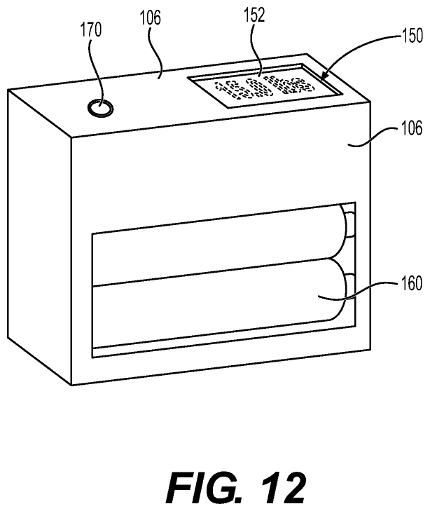

Referring again to FIG. 11, the power supply 160 is configured to supply power to the controller 110 and the display 150. For example, the power supply 160 may include one or more batteries. As a non-limiting example, the power supply 160 may include 2 AAA batteries. As shown in FIG. 12, the display housing 106 may include a battery compartment 107 configured to accommodate the one or more batteries therein. However, the power source 160 is not limited to the aforementioned configuration. In other examples, the power source 160 may include one or more batteries accommodated on the PCB 102 or in a battery housing in a separate portion of the base 10.

Referring to FIG. 11, the command button 170 is operable to set an operating mode of the scale 100 and to set a display format of the weight information displayed by the display 150. More specifically, as described later in more detail, the command button 170 is configured to receive physical inputs (e.g., push inputs by a person's finger or other object) to perform various functions. For example, when the scale 100 is in a fully operational or high power mode (described later), the command button 170 may be pushed or otherwise actuated to change the format of the weight information displayed by the display 150 from one unit of measurement (e.g., pounds) to another unit of measurement (e.g., kilograms). Additionally, when the scale 100 is in a low power mode (described later), the command button 170 may be pushed or otherwise actuated to exit the low power mode and place the scale 100 in the fully operational mode.

As illustrated in FIGS. 9, 10, and 12, the command button 170 may be disposed in the display housing 106. However, the command button 170 is not limited to being disposed in the display housing 106. In other examples, the command button 170 may be disposed in one of the side panels 24, 26, 28, and 30 of the base 20. In another embodiment, more than one command button 170 may be provided, and each command button 170 may be configured to perform a different function (e.g., change the format of the weight information displayed on the display 150 from one unit of measurement to another unit of measurement, or place the scale 100 in the fully operational mode when the scale 100 is in the low power mode).

Referring to FIGS. 4 and 11, the load sensors 180 are configured to sense a force applied the load sensors 180. As described in more detail later, the one or more processors 120 calculate the weight of the luggage case 10 based on the force applied to the load sensors 180. The load sensors 180 may be load cells or, more specifically, strain gauge load cells, but are not limited thereto. For example, the load sensors 180 may be half-bridge type load cells. The scale 100 may include four (4) load sensors 180, and the load sensors 180 may be spaced apart at defined spacing intervals on or in the rear panel 22 of the base 20. However, in other embodiments, the number of load sensors 180 provided in the luggage case 10 may be greater or less than four, and the load sensors 180 may be disposed in another portion of the base 20. The load sensors 180 may be connected to the controller 110 by wires disposed in or on one or more panels (e.g., the rear panel 22 and the side panel 26) of the base 20.

As described above, the scale 100 may further include the magnetic switch 190 and the magnet 196. The magnetic switch 190 may be connected to the power source 160 by wires disposed in or on a panel (e.g., the side panel 26) of the base 20, and is configured to detect a magnetic field generated by the magnet 196 when the magnet 196 is within a defined distance from a magnetic sensing member 192 of the magnetic switch 190. For example, the magnetic switch 190 may be a reed switch, a hall effect switch, or a transistor switch, but is not limited to these examples. In an embodiment, the magnetic switch 190 may be turned off, or opened, when the magnetic switch 190 senses an applied magnetic field, and may be turned on, or closed, when the magnetic switch 190 does not sense an applied magnetic field. Thus, the magnetic switch 190 may be switched off when the magnet 196 is within the defined distance from the magnetic sensing member 192 of the magnetic switch 190, and may be switched on when the magnet 196 is outside of the defined distance from the magnetic sensing member 192 of the magnetic switch 190.

Referring to FIGS. 9 and 10, the magnetic switch 190 may include the magnetic sensing member (hereinafter, “sensing member”) 192 disposed in the base 20. The sensing member 192 may be disposed in or on one of the side panels 26, 28, and 30 of the base 20. The magnet 196 may be disposed in or on one of the side panels 46, 48, and 50 of the cover 40 that aligns with the one of the side panels 26, 28, and 30 of the base 20 including the magnet 196 when the cover 40 is closed. For example, the sensing member 192 may be disposed in or on the side panel 26 and the magnet 196 may be disposed in or on the side panel 46, such that the sensing member 192 and the magnet 192 face each other when the cover 40 is closed. In an embodiment, the sensing member 192 may be disposed in the display housing 106, or at a surface of the display housing 106, near an outer edge portion of side panel 26, and the magnet 196 may be disposed in, on, or near an outer edge portion of the side panel 46 that aligns with the outer edge portion of the side panel 26 when the cover 40 is closed. Alternatively, the sensing member 192 may be disposed at or near an edge portion of the side panel 46 in a location other than that of the display housing 106.

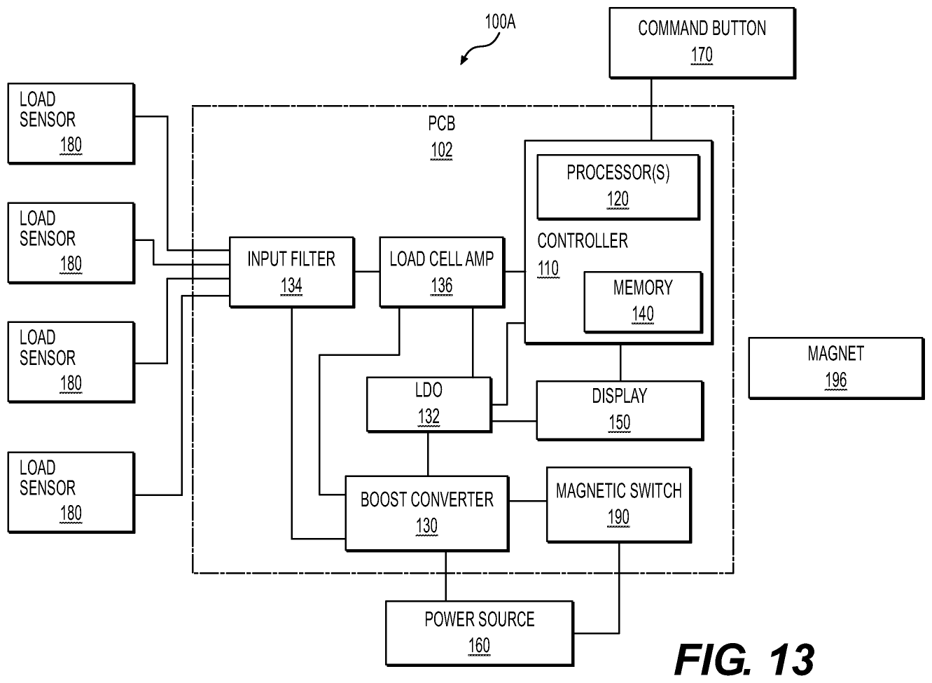

FIG. 13 is a schematic diagram of scale 100A, according to another embodiment. The scale 100A may be included in the luggage case 10 instead of the scale 100, and may perform the same functions as those performed by the scale 100.

Referring to FIG. 13, the scale 100A may include the components of the scale 100, and may further include a boost converter 130, a low-dropout (LDO) regulator 132, an input filter 134, and a load sensor amplifier 136, each of which may be mounted on the PCB 102.

The boost converter 130 may be, for example, a 5V boost converter, but is not limited to a particular boost voltage. As shown in FIG. 13, the boost converter 130 has an input connected to the magnetic switch 190, and outputs respectively connected to the LDO 132, the input filter 134, and the load sensor amplifier 136 to supply power to the LDO 132, the input filter 134, and the load sensor amplifier 136.

The LDO 132 may provide a regulated output voltage of 2.8V, for example. However, the LDO is not limited to a particular output voltage. As shown in FIG. 13, an input of the LDO 132 is connected an output of the boost converter 130, and outputs of the LDO 132 are respectively connected to the load sensor amplifier 136, the controller 110, and the display 150 to supply power to the load sensor amplifier 136, the controller 110, and the display 150.

Still referring to FIG. 13, the input filter 134 is connected to the load sensors 180 and is configured to filter noise out of sensing signals from the load sensors 180. For example, the input filter 134 may be an RC low pass filter or a digital low pass filter.

Referring again to FIG. 13, the load sensor amplifier 136 may be an op amp, and has an input connected to an output of the input filter 134. The load sensor amplifier 134 amplifies filtered sensing signals output by the input filter 134.

The scale 100/100A may be configured to operate efficiently to minimize power consumption, thereby extending battery life of the power source 160. Further, the scale 100 may be configured to operate in a manner that facilitates compliance with the United States Transportation Security Administration (TSA) and Federal Aviation Administration (FAA) rules requiring that electronic devices be powered off at certain times during air travel. Accordingly, since the luggage case 10 will typically be in its closed configuration illustrated in FIGS. 1-8 (in which the cover 40 is in the closed position) while being transported and not being accessed by a person, the scale 100 may be configured to automatically power off, such that no component of the scale 100 receives power from the power source 160, when the luggage case 10 is placed in the closed configuration, and may remain completely powered off as long as the luggage case 10 is in the closed configuration. Further, the scale 100 may automatically power on when the luggage case 10 is placed in the open configuration illustrated in FIGS. 9 and 10 (in which the cover 40 is in the open position), and may remain powered on during a time period in which the luggage case 10 is in the open configuration. Thus, to extend battery life and ensure compliance with regulatory requirements for air travel, the scale 100/100A may only turn on/receive power only when the luggage case 10 is in the open configuration.

More specifically, referring to FIGS. 1-8, when the luggage case 10 is in the closed configuration, the sensing member 192 and the magnet 196 are disposed within a threshold distance from each other, such that the magnetic switch 190 senses the magnetic field of the magnet 196 and is open, or “off,” to prevent power from being provided to the controller 110. For example, in the embodiment of FIG. 12, when the magnetic switch 190 senses the magnetic field of the magnet 196, power from the power source 160 is not supplied to the boost converter 130, thereby not providing power to the LDO 132, the input filter 134, the load cell amp 136, the controller 110, and the display 150.

Referring to FIGS. 9 and 10, when the luggage case 10 is in the open configuration, the sensing member 192 and the magnet 196 are disposed outside of a threshold distance from each other, such that the magnetic switch 190 does not sense the magnetic field of the magnet 196 and is closed, or “on,” to provide power from the power source 160 to the controller 110. For example, in the embodiment of FIG. 13, when the magnetic switch 190 does not sense the magnetic field of the magnet 196, power from the power source 160 is supplied to the boost converter 130, thereby providing power to the LDO 132, the input filter 134, the load cell amp 136, the controller 110, and the display 150. Accordingly, the scale 100/100A is powered on when the luggage case 10 is in the open configuration. Once the scale 100/100A is initially powered on, the scale 100/100A enters a fully operational mode in which signal sampling and weight measurement based on sensing signals generated by the load sensors 80 are enabled, and the display is activated such that weight information indicating a weight of the luggage case 10 and other information may be displayed on the display screen 152.

In a modified embodiment, a switch including a first electrical contact disposed on the base 20 may replace the magnetic switch 190, and a second electrical contact disposed on the cover 40 may replace the magnet 196. According to such a modified embodiment, the scale 100/100A may be completely powered off when the cover 40 is closed such that first and second electrical contacts are in contact with each other, and may be powered on when the cover 40 is open such that the first and second electrical contacts are not in contact with each other. In such a modified embodiment, the second electrical contact may be connected to the power source by wires disposed in or on the cover 40 and the base 20.

When the scale 100/100A is fully operational, the controller 110 determines the weight of the luggage case 10 based on the sensing signals generated by the load sensors 180. In the embodiment of FIG. 13, the controller 110 determines the weight of the luggage based on the filtered sensing signals received from the input filter 134.

In an embodiment, when the luggage case 10 is in the open configuration and the scale 100/100A is in the fully operational mode, the controller 110 will calculate a current weight of the luggage case 10 upon each instance of an item being placed the luggage case 10, and display weight information indicating the current weight of the luggage case 10 on the display screen 152. That is, each time a load sensed by the load sensors 180 changes while the luggage case is in the open configuration, the controller 110 may recalculate the current weight of the luggage case 10. Thus, weight information displayed by the display 150 will be repeatedly updated as multiple items are respectively placed in the luggage case 10.

Additionally, the controller 110 may be programmed to determine when the weight of the luggage case 10 exceeds a weight threshold, and generate an alarm signal to indicate that the weight of the luggage case 10 exceeds the weight threshold. For example, the weight threshold may correspond to a maximum weight threshold set for carry-on luggage by an airline, a maximum weight threshold set for applying a surcharge for checked luggage by an airline, or a maximum weight threshold set for luggage stored by a common carrier for ground or water travel. The alarm signal generated by the controller 110 may cause the display 150 to generate a corresponding visual alarm, such as flashing of the display screen 152 or a graphic symbol displayed on the display screen 152. Alternatively, or in addition to the visual alarm, the alarm signal generated by the controller 110 may cause an audio device (e.g., a speaker) connected to the controller 110 to generate an audible alarm and/or may cause a haptic device connected to the controller 10 to generate a haptic alarm.

The scale 100/100A may remain in the fully operational mode when the luggage case 10 is in the open configuration, until the controller 110 determines that items are no longer being placed in the luggage case 10. The format of the weight information displayed by the display 150 may be changed from one unit of measurement to another at any time while the scale 100/100A is in the fully operational mode, by a person pressing or otherwise actuating the command button 170.

According to an embodiment, the controller 110 may determine, based on the sensing signals generated by the load sensors 180 remaining substantially the same over a predefined measurement time period while the luggage case 10 is in the open configuration, that items are no longer being placed in the luggage case 10. To extend the life of the power source 160, the scale 100/100A may enter a low power mode, or sleep mode, in response to the controller 110 determining that that items are no longer being placed in the luggage case 10 while the luggage case 10 is in the open configuration. Upon determining to enter the low power mode, the controller 110 may save the latest measured weight of the luggage case 10 in the memory 126. In the low power mode, the controller 110 and the load cell amplifier 136 still receive power from the power source 160, but the controller 110 powers down such that it does not perform signal sampling, the load cell amplifier 136 powers down, and a switch of the display 150 turns off such that the display 150 is deactivated. Thus, in the low power mode, power consumption is reduced and the controller 110 does not measure the weight of the luggage case 10.

The scale 100/100A may be completely powered off, when in the fully operational mode or the low power mode, by a person closing the cover 40 to place the luggage case 10 in the closed configuration. When being powered on again after being completely powered off, the scale 100/100A is reset such that the controller 110 is reset, and all counters (e.g., a counter implemented for a timer to measure time while the scale 100/100A is fully operational to weigh items, and counters for sampling of signals generated by the load cells 180) and weight data from the previous fully operational mode of the scale 100/100A are cleared from the memory 110.

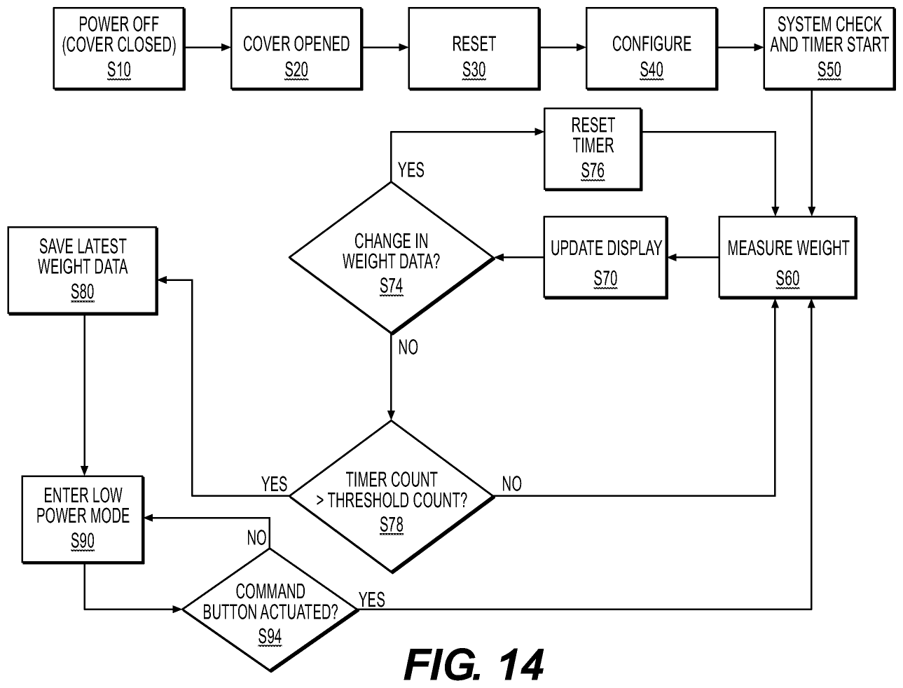

Operations of the scale 100/100A in an example method of weighing the luggage case are illustrated in FIG. 14.

Referring to FIG. 14, in operation S10, the luggage case 10 is initially in the closed configuration, and the scale 100/110 is therefore in the state in which it is powered off. Then, in operation S20, the cover 40 of the luggage case 10 is opened to place the luggage case 10 in the open configuration.

Next, in operation S30, the scale 100/100A is reset. For example, when the scale 100/100A is reset, the controller 110 is reset, and all counters and weight data from any previous fully operational mode of the scale 100/100A are cleared from the memory 110.

After operation S30, the scale 100/100A is configured in operation S40. For example, in operation S40, the hardware on the PCB 102 is set up, previous data is loaded from the memory 126 by the controller 110, and a logo or other greeting information may be displayed by the display 150. Next, in operation S50, the controller 110 performs a system check, in which the controller checks status of the battery, checks for weight data generated from the sensing signals generated by the load sensors 180, and starts a timer.

Thereafter, in operation S60, the controller 110 measures the weight of the luggage case 10 based on the generated weight data. Then, in operation S70, the controller 110 updates the display 150 by controlling the display 150 to display updated weight information on the display screen 152 corresponding to the generated weight data.

In operation S74, the controller 110 determines whether there is a change in weight data generated by the load sensors. If the controller 110 determines, in operation S74, that there is a change in the weight data generated from the sensing signals, the controller 110 resets the timer in operation S76 and then performs operation S60 again.

If the controller 110 determines, in operation S74, that there is no change in the weight data generated from the sensing signals, the controller 110 then determines, in operation S78, whether a count of the timer exceeds a threshold count.

If the controller 110 determines, in operation S78, that the value of the timer does not exceed the threshold value, the controller 110 preforms operation S60 again.

If the controller 110 determines, in operation S78, that the value of the timer exceeds the threshold value, the controller 110 saves the latest weight data and/or latest measured weight in operation S80, and the scale 100/100A then enters the low power mode in operation S90. As described above, when the scale 100/100A is in the low power mode, the controller 110 powers down such that it does not perform signal sampling, the load cell amplifier 136 powers down, and the display 150 is deactivated.

Further, following operation S90, the command button 170 may be pushed in operation S94, while the scale 100/100A is in the low power mode. In response to an input received from the command button 170 being pushed in operation S94, the scale 100/100A returns to the fully operational mode, and operation S60 is performed again.

If the command button 170 is pressed at any point between operations S50 and S80, the display 150 is updated, based on an input received from the command button 170, to change the format of the weight information displayed by the display 150, as described above. Additionally, if the luggage case 10 is closed at any point following operation S20, the scale 100/100A is completely powered off.

According to embodiments disclosed herein, a luggage case includes a scale that enables a weight of the scale to be determined easily and efficiently. For example, according to embodiments disclosed herein, the scale is configured to determine the weight of the luggage case while the luggage case is open and being loaded with items. Additionally, according to embodiments disclosed herein, the scale is configured to automatically power on in response to the luggage case being opened. Additionally, according to embodiments disclosed herein, the scale is configured to automatically power off in response to the luggage case being opened, to extend battery life of the scale and to ensure that the scale remains powered off while being transported in air travel, for compliance with airline regulations regarding electronic devices. Further, according to embodiments, the scale is configured to enter a low power mode when it determines that the luggage case is open and items are no longer being placed in the luggage case, to extend the battery life of the scale.

The controller 110, the one or more processors 120, and the memory 126 in FIGS. 1-14 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-14 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A luggage case, comprising:
a base configured to accommodate items therein;
a cover disposed on the base; and
a scale including:
one or more load sensors disposed on the base, and
a controller configured to determine a weight of the luggage case based on signals generated by the one or more load sensors,
wherein the scale is configured to be automatically powered on in response to the cover being placed in an open position at least partially exposing an interior space of the base.

2. The luggage case of claim 1, wherein the scale further includes:
a magnetic switch connected to a power source and the controller, and including a sensing member disposed in the base; and
a magnet disposed in the cover,
wherein the magnetic switch is configured to electrically connect the controller to the power source, in response to the sensing member failing to sense the magnet.

3. The luggage case of claim 2, wherein the sensing member is disposed at an edge portion of the base and the magnet is disposed at an edge portion of the cover that aligns with the edge portion of the base when the cover is in a closed position in which the cover and the base enclose an interior space of the luggage case.

4. The luggage case of claim 2, wherein the scale further includes a display disposed in a display housing mounted at or near a side wall of the base, the display being configured to display weight information indicating the determined weight,
wherein the sensing member is disposed in or on the display housing, and the magnet is disposed at an edge portion of the cover that aligns with the display housing when the cover is in a closed position in which the cover and the base enclose an interior space of the luggage case.

5. The luggage case of claim 1, wherein the scale is further configured to be automatically powered off in response to the cover being placed in a closed position in which the cover and the base enclose an interior space of the luggage case.

6. The luggage case of claim 5, wherein the scale further includes:
a magnetic switch connected to a power source and the controller, and including sensing member disposed in the base; and
a magnet disposed in the cover,
wherein the magnetic switch is configured to electrically disconnect the controller from the power source, in response to the sensing member sensing the magnet.

7. The luggage case of claim 1, wherein the scale is further configured to power down to a low power mode, in response to the controller determining that loading of items in the luggage case has stopped while the cover is in the open position.

8. The luggage case of claim 7, wherein the scale further includes a display configured to display weight information indicating the determined weight, and
wherein the display is disabled in the low power mode.

9. The luggage case of claim 7, wherein the scale is configured to return to a fully operational mode from the low power mode, in response to an input from a command button on the luggage case.

10. The luggage case of claim 1, wherein the scale further includes a display configured to display weight information based on the determined weight,
wherein the controller is further configured to redetermine the weight of the luggage case in response to an item being placed in the luggage case, and
wherein the display is further configured to update the displayed weight information based on the redetermined weight.

11. A luggage case, comprising:
a base configured to accommodate items therein;
a cover disposed on the base; and
a scale including:
one or more load sensors disposed on the base, and
a controller configured to determine a weight of the luggage case based on signals generated by the one or more load sensors,
wherein the scale is configured to be automatically powered off in response to the cover being placed in a closed position in which the cover and the base enclose an interior space of the luggage case.

12. The luggage case of claim 11, wherein the scale further includes:
a magnetic switch connected to a power source and the controller, and including a sensing member disposed in the base; and
a magnet disposed in the cover,
wherein the magnetic switch is configured to electrically disconnect the controller from the power source, in response to the sensing member sensing the magnet.

13. The luggage case of claim 11, wherein the sensing member is disposed at an edge portion of the base and the magnet is disposed at an edge portion of the cover that aligns with the edge portion of the base when the cover is in the closed position.

14. The luggage case of claim 11, wherein the scale further includes a display disposed in a display housing mounted at or near a side wall of the base, the display being configured to display weight information indicating the determined weight,
wherein the sensing member is disposed in or on the display housing, and the magnet is disposed at an edge portion of the cover that aligns with the display housing when the cover is in a closed position in which the cover and the base enclose an interior space of the luggage case.

15. A method of weighing a luggage case, comprising:
powering on, by a power source, an electronic scale in the luggage case, in response to a cover of the luggage case being placed in an open position at least partially exposing an interior space of a base of the luggage case; and
measuring, by a controller of the electronic scale, a weight of the luggage case based on weight data generated from signals generated by one or more load sensors disposed on the luggage case.

16. The method of claim 15, further comprising further measuring, by the controller, the weight of the luggage case, in response to the controller determining that there is a change in the weight data generated from the signals.

17. The method of claim 15, further comprising further measuring, by the controller, the weight of the luggage case, in response to the controller determining that:
there is no change in the weight data generated from the signals; and
a count of a timer started before the measuring of the weight does not exceed a threshold count.

18. The method of claim 15, further comprising powering down, by the controller, the electronic scale to a low power mode, in response to the controller determining that:
there is no change in the weight data generated from the signals; and
a count of a timer started before the measuring of the weight exceeds a threshold count.

19. The method of claim 18, further comprising returning the electronic scale to a fully operational mode from the low power mode, in response to an input received from a command button.

20. The method of claim 15, further comprising powering off the electronic scale, by the controller, in response to the cover being placed in a closed position in which the cover and the base enclose an interior space of the luggage case.
